(19) United States
(12) Patent Application Publication
(10) Pub. No.: US 2024/0266772 A1
(43) Pub. Date: Aug. 8, 2024

(54) CONNECTOR

(71) Applicant: SUMITOMO WIRING SYSTEMS, LTD., Mie (JP)

(72) Inventor: Masashi UCHIDA, Mie (JP)

(21) Appl. No.: 18/420,206

(22) Filed: Jan. 23, 2024

(30) Foreign Application Priority Data
Feb. 2, 2023 (JP) 2023-014446

(51) Int. Cl. H01R 13/207; H01R 4/34; H01R 11/12; H01R 13/52; H01R 13/627

(52) U.S. Cl. CPC H01R 13/207; H01R 4/34; H01R 11/12; H01R 13/521; H01R 13/6275; H01R 2201/26

(57) ABSTRACT

A connector includes a housing and a terminal assembly. The housing includes a housing body portion having a through hole penetrating in a first direction. The terminal assembly includes a terminal, a holding component to be inserted into the through hole together with the terminal, a sealing member for sealing between an inner wall of the through hole and the terminal by being directly mounted on the terminal and a nut to be mounted and temporarily held in the holding component. The holding component includes a terminal insertion hole, into which the terminal is inserted, a terminal positioning portion for positioning the terminal inserted into the terminal insertion hole and a nut positioning portion provided to be continuous with the terminal positioning portion for positioning the nut. The housing includes a nut holding wall for holding the nut in a state positioned by the nut positioning portion.

### CROSS-REFERENCE TO RELATED APPLICATIONS

This application is based on and claims priority from Japanese Patent Application No. 2023-014446, filed on Feb. 2, 2023, with the Japan Patent Office, the disclosure of which is incorporated herein in its entirety by reference.

### TECHNICAL FIELD

The present disclosure relates to a connector.

### BACKGROUND

A connector described in Japanese Patent Laid-open Publication No. 2012-243636 is known as a connector for preventing the intrusion of a liquid such as water or oil into a housing. This connector is provided with a housing, a terminal, an O-ring, a fastener and an O-ring holder, and the O-ring is directly mounted on the terminal. The housing is formed with a terminal insertion hole, and the terminal is inserted into this terminal insertion hole. Further, the housing is provided with an O-ring mounting recess communicating with the terminal insertion hole. The O-ring is mounted on the terminal to surround the entire periphery of the terminal. If the terminal is inserted into the terminal insertion hole, the O-ring is fit into the O-ring mounting recess and the inside of the terminal insertion hole is sealed.

An end part of the terminal is formed with a fastening hole. With the terminal inserted in the terminal insertion hole, the fastening hole is arranged in a fastening portion of the housing. A fastening nut is fixed in the fastening portion of the housing by press-fitting. On the other hand, a mating terminal, which is a connection partner of the terminal, is formed with an insertion hole. The mating terminal and the terminal are connected by inserting a fastening screw into the insertion hole and the fastening hole and screwing and fastening the fastening screw into the fastening nut after the mating terminal is so overlaid on the terminal that the insertion hole of the mating terminal and the fastening hole of the terminal communicate.

### SUMMARY

However, if a position shift occurs during press-fitting into the fastening nut, the fastening nut is fixed while being shifted in position, and the fastening screw and the terminal are fastened on the basis of the fastening nut shifted in position. As a result, there is a concern that the O-ring directly mounted on the terminal is also shifted in position and a waterproof function is reduced.

The present disclosure was completed on the basis of the above situation and aims to improve the positioning accuracy of a nut and, hence, ensure a waterproof function.

The present disclosure is directed to a connector with a housing and a terminal assembly, the housing including a housing body portion having a through hole penetrating in a first direction, the terminal assembly including a terminal, a holding component to be inserted into the through hole together with the terminal, a sealing member for sealing between an inner wall of the through hole and the terminal by being directly mounted on the terminal and a nut to be mounted and temporarily held in the holding component, the holding component including a terminal insertion hole, the terminal being inserted into the terminal insertion hole, a terminal positioning portion for positioning the terminal inserted into the terminal insertion hole and a nut positioning portion provided to be continuous with the terminal positioning portion for positioning the nut, and the housing including a nut holding wall for holding the nut in a state positioned by the nut positioning portion.

According to the present disclosure, the positioning accuracy of a nut can be improved and, hence, a waterproof function can be ensured.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector when viewed obliquely from an upper front side.

FIG. 2 is a front view of the connector.

FIG. 3 is a side view of the connector.

FIG. 4 is a section along A-A of FIG. 2.

FIG. 5 is a section along B-B of FIG. 2.

FIG. 6 is a perspective view showing a state before a first terminal assembly is mounted into a housing when viewed obliquely from the upper front side.

FIG. 7 is a perspective view showing a state before an insulating member and a third sealing member are mounted on a terminal when viewed obliquely from the upper front side.

FIG. 8 is a perspective view showing a state before the terminal is mounted into a holding component when viewed obliquely from the upper front side.

FIG. 9 is a bottom view showing a state before a nut is mounted into the holding component when viewed from below.

FIG. 10 is a bottom view showing a state after the nut is mounted into the holding component of FIG. 9 when viewed from below.

FIG. 11 is a perspective view of the first terminal assembly when viewed obliquely from a lower front side.

FIG. 12 is a perspective view of the first terminal assembly when viewed obliquely from the upper front side.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

First, embodiments of the present disclosure are listed and described.
[1] The connector of the present disclosure is provided with a housing and a terminal assembly, the housing including a housing body portion having a through hole penetrating in a first direction, the terminal assembly including a terminal, a holding component to be inserted into the through hole together with the terminal, a sealing member for sealing between an inner wall of the through hole and the terminal by being directly mounted on the terminal and a nut to be mounted and temporarily held in the holding component, the holding component including a terminal insertion hole, the terminal being inserted into the terminal insertion hole, a terminal positioning portion for positioning the terminal inserted into the terminal insertion hole and a nut positioning portion provided to be continuous with the terminal positioning portion for positioning the nut, and the housing including a nut holding wall for holding the nut in a state positioned by the nut positioning portion.

Since the nut is mounted into and temporarily held in the holding component, the nut needs not be press-fit and problems such as the forgetting to press-fit the nut and a position shift of the nut during press-fitting can be prevented. Further, since the sealing member is directly mounted on the terminal, the terminal and the sealing member are positioned by the terminal positioning portion and the nut is positioned by the nut positioning portion by respectively mounting the terminal and the nut into the holding component. As a result, the terminal assembly including the terminal, the nut and the sealing member relatively positioned by one component, i.e. the holding component, can be configured, and a component for positioning the sealing member is not necessary in addition to the holding component. Thus, component cost can be reduced.

Since the nut can be held positioned by the nut holding wall, the positioning accuracy of the nut can be improved. Here, in fastening the mating terminal and the terminal by the bolt and the nut, the mating terminal and the terminal are fastened on the basis of the position of the nut held positioned. That is, since the terminal is not shifted in position by fastening and the terminal is held positioned, a waterproof function can be ensured by evenly squeezing the sealing member.
[2] Preferably in [1] described above, the nut holding wall includes a base plate portion for suppressing separation of the nut by arranging the nut between the terminal and the base plate portion.

Since the nut is arranged between the base plate portion and the terminal, the separation of the temporarily held nut from the holding component can be suppressed.
[3] Preferably in [1] or [2] described above, the nut holding wall includes a side plate portion for stopping rotation of the nut by engaging an outer peripheral surface of the nut.

Since the side plate portion engages the outer peripheral surface of the nut, the nut can be suppressed from rotating and being shifted in position when the mating terminal and the terminal are fastened.
[4] Preferably in [3] described above, the side plate portion includes a locked portion, and the holding component includes a locking portion for holding the terminal assembly in a state mounted in the housing body portion by locking the locked portion.

If the terminal assembly is mounted into the housing body portion, the terminal assembly can be held in the housing body portion by locking the locking portion of the holding component to the locked portion of the side plate portion.
[5] Preferably in [4] described above, the holding component includes a deflectable deflection piece and the locking portion is provided on the deflection piece.

If the deflection piece is deflected and deformed while the terminal assembly is being mounted into the housing, the locking portion rides over the locked portion. The deflection piece is restored at the same time as the locking portion rides over the locked portion, whereby the locking portion locks the locked portion. Thus, the terminal assembly can be easily mounted into the housing body portion by hand.
[6] Preferably in any one of [1] to [5] described above, the nut positioning portion includes a temporary holding rib for sandwiching and temporarily holding the nut in the first direction.

The nut can be temporarily held in the holding component by being sandwiched in the first direction by the temporary holding rib.

### DETAILS OF EMBODIMENT OF PRESENT DISCLOSURE

A specific example of a connector of the present disclosure is described below with reference to the drawings. For the convenience of description, some components may be shown in an exaggerated or simplified manner in each drawing. Further, a dimension ratio of each part may be different in each figure. “Parallel”, “perpendicular” and “orthogonal” in this specification mean not only strictly parallel, perpendicular and orthogonal, but also substantially parallel, perpendicular and orthogonal within a range in which functions and effects in this embodiment are achieved.

In each figure, three directions perpendicular to each other are shown and these three directions are respectively shown as a first direction D1, a second direction D2 and a third direction D3. That is, the first and second directions D1, D2 are perpendicular to each other, the first and third directions D1, D3 are perpendicular to each other and the second and third directions D2, D3 are perpendicular to each other. Since arrows are drawn on both sides of a solid line indicating each direction, not only a direction of the arrow on a side where a sign is attached, but also a direction of the arrow on a side where no sign is attached indicates this direction.

Further, a term “tubular” used in the description of this specification indicates not only a shape formed by a peripheral wall continuous over an entire periphery in a circumferential direction, but also a shape formed by combining a plurality of components and a shape having a cut or the like in a circumferential part such as a C shape. Further, the “tubular” shapes include circular shapes, elliptical shapes and polygonal shapes with angular or rounded corners.

Further, a term “ring” in this specification means an arbitrary closed shape having an outer edge connected by straight lines or curves, including a circular ring having a circular outer edge, a ring having an elliptical or oval outer edge, a polygonal ring having a polygonal outer edge and a ring having a polygonal outer edge with rounded corners. The “ring” may be shaped such that an outer edge shape and an inner edge shape have the same shape or may be shaped such that an outer edge shape and an inner edge shape are different. The “ring” may have a predetermined length along a center axis direction, and the length does not matter. Further, an “annular shape” in this specification only has to be regarded as a ring as a whole and may include a cut, a slit or the like in a part such as a C shape.

Further, “facing each other” in this specification indicates that surfaces or members are at positions in front of each other, and means not only a case where the surfaces or members are at positions perfectly in front of each other, but also a case where the surfaces or members are partially in front of each other. Further, “facing each other” in this specification means both a case where another member different from two parts is interposed between the two parts and a case where nothing is interposed between the two parts.

### Embodiment

### (Configuration of Connector 10)

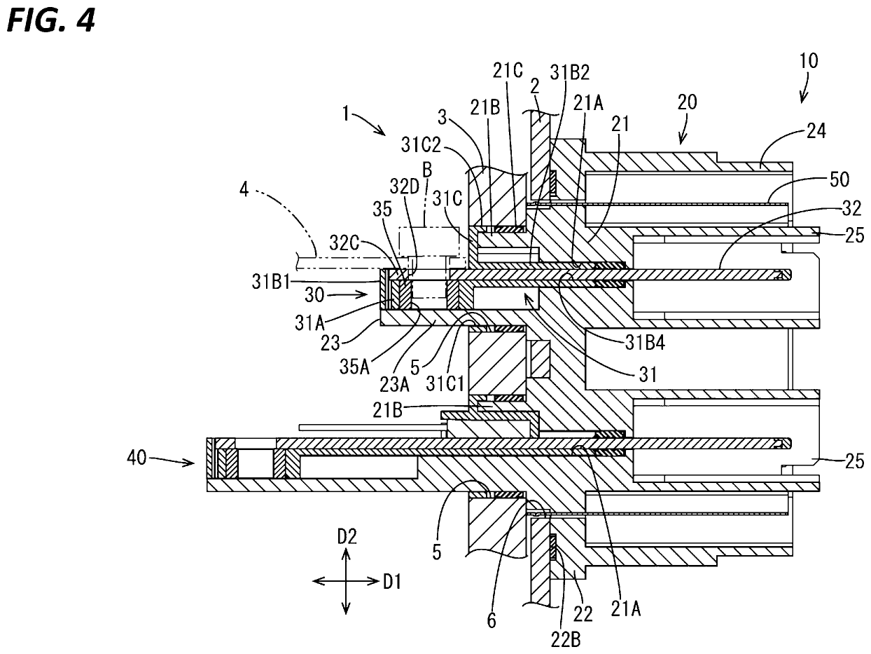

A connector 10 is to be connected to a mating device 1 for vehicle. The mating device 1 is, for example, a high-voltage battery, a motor or the like for drive. As shown in FIG. 4, the mating device 1 is provided with an enclosure 2 made of an electrically conductive metal material and a mating housing 3 and mating terminals 4 provided in the enclosure 2. The mating housing 3 is provided with a pair of upper and lower fitting recesses 5. The enclosure 2 is provided with a mating hole 6 penetrating in the first direction D1.

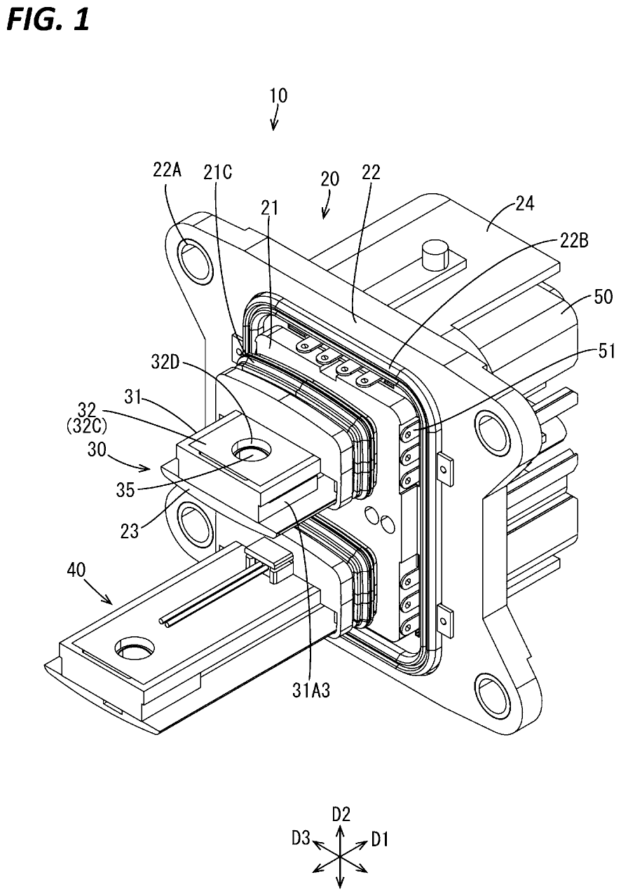

As shown in FIG. 1, the connector 10 is provided with a housing 20 and a pair of upper and lower terminal assemblies 30, 40 disposed side by side in the second direction D2. Out of the pair of upper and lower terminal assemblies 30, 40, the upper one is a first terminal assembly 30 and the lower one is a second terminal assembly 40. The respective terminal assemblies 30, 40 are different in length in the first direction D1, but are substantially similarly configured. Thus, the first terminal assembly 30 is described as a representative for common components.

### (Configuration of Housing 20)

As shown in FIG. 4, the housing 20 is provided with a housing body portion 21, a mounting plate 22 protruding toward an outer peripheral side of the housing body portion 21, a pair of upper and lower nut holding walls 23 disposed side by side in the second direction D2, a receptacle 24 and a pair of upper and lower terminal accommodation walls 25 disposed side by side in the second direction D2. A resin material such as polybutylene terephthalate (PBT) can be cited as a material of the housing 20.

### (Configuration of Housing Body Portion 21)

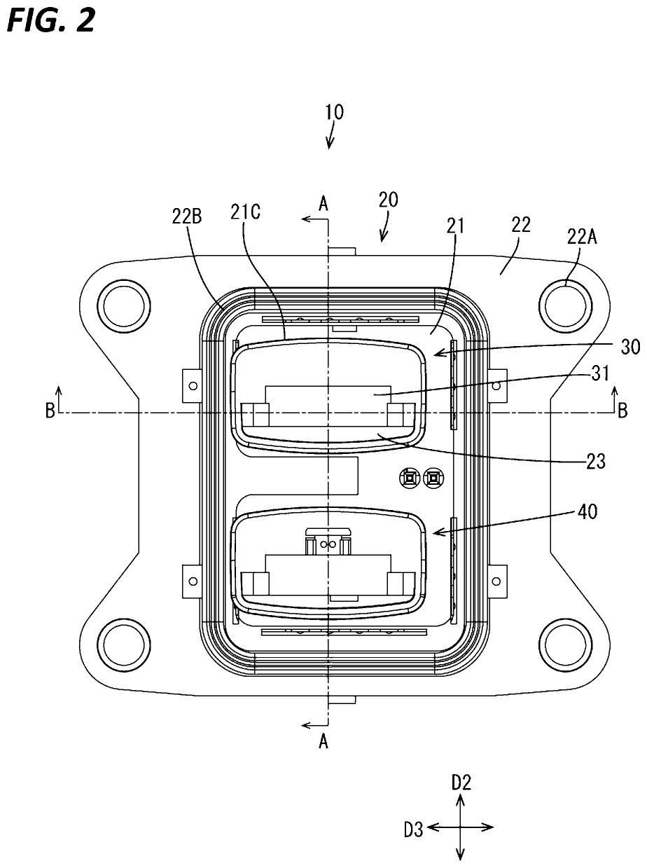

The housing body portion 21 includes a pair of upper and lower through holes 21A, into which the respective terminal assemblies 30, 40 are mounted. The housing body portion 21 includes a pair of upper and lower fitting portions 21B fittable into the pair of upper and lower fitting recesses 5 of the enclosure 2. As shown in FIG. 2, the housing body portion 21 is in the form of a substantially rectangular block long in a vertical direction when viewed from the first direction D1.

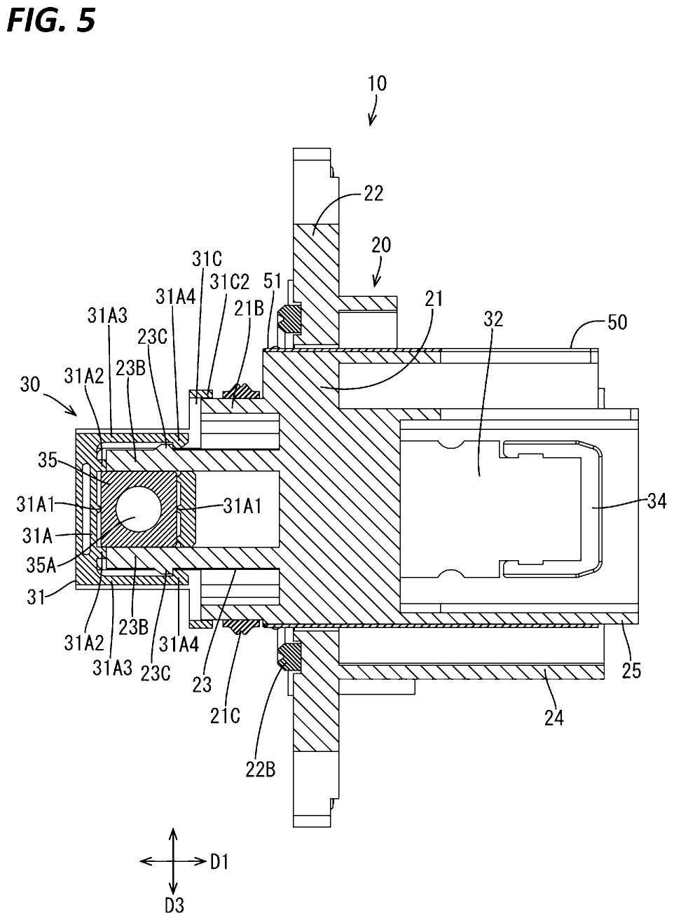

As shown in FIG. 5, an annular first sealing member 21C is mounted on the outer peripheral surface of the fitting portion 21B. The first sealing member 21C is a shaft seal. If the fitting portion 21B is fit into the fitting recess 5, the first sealing member 21C is compressed over an entire periphery by the outer peripheral surface of the fitting portion 21B and the inner peripheral surface of the fitting recess 5 as shown in FIG. 4, whereby the inside of the mating housing 3 is sealed.

### (Configuration of Mounting Plate 22)

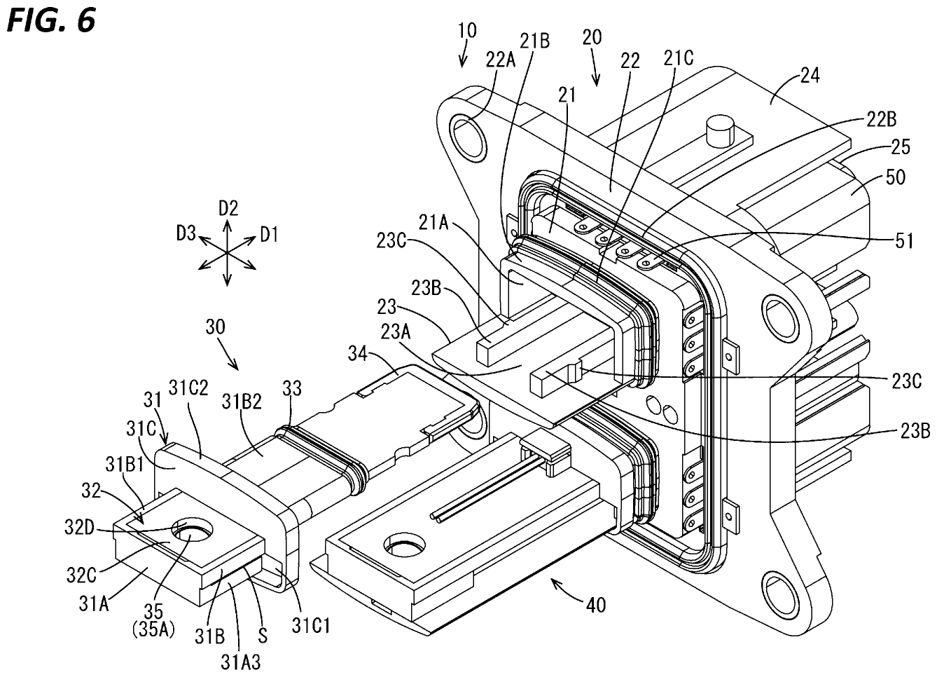

As shown in FIG. 6, the mounting plate 22 is a part protruding in the second and third directions D2, D3 from the outer peripheral surface of the housing body portion 21. The mounting plate 22 is in the form of a substantially rectangular plate when viewed from the first direction D1. Collars 22A made of metal are fixed at four corners of the mounting plate 22 by press-fitting or insert molding. The connector 10 is mounted and fixed to the mating device 1 by inserting bolts into the collars 22A and tightening the bolts into bolt holes of the enclosure 2.

A second sealing member 22B is mounted on a surface of the mounting plate 22 facing the enclosure 2. The second sealing member 22B is a surface seal. If the connector 10 is mounted on the mating device 1, the second sealing member 22B is compressed by the enclosure 2 and the mounting plate 22 and the inside of the enclosure 2 is sealed as shown in FIG. 4.

A shield member 50 made of metal is mounted between the housing body portion 21 and the mounting plate 22. The shield member 50 is substantially in the form of a rectangular tube when viewed from the first direction D1. Parts of the first and second terminal assemblies 30, 40 disposed outside the enclosure 2 are located inside the shield member 50. As shown in FIG. 6, the shield member 50 includes a plurality of contact pieces 51 to be brought into contact with the enclosure 2 when the connector 10 is mounted on the mating device 1.

### (Configuration of Nut Holding Wall 23)

The nut holding wall 23 includes a plate-like base plate portion 23A formed to project in the first direction D1 from the bottom wall of the fitting portion 21B and a pair of side plate portions 23B extending in the first direction D1 from the upper surface of the base plate portion 23A to the upper surface of the inner wall of the through hole 21A. The pair of side plate portions 23B are disposed side by side in parallel in the third direction D3. The tip of the side plate portion 23B is disposed between the opening edge of the fitting portion 21B and the tip of the base plate portion 23A. A pair of locked portions 23C are provided on the outer side surfaces of the pair of side plate portions 23B.

As shown in FIG. 4, a nut 35 is supported by the base plate portion 23A with the first terminal assembly 30 mounted in the housing body portion 21. Since the nut 35 is fit and accommodated between the base plate portion 23A and a terminal connecting portion 32C of the terminal 32, the nut 35 is held positioned in the second direction D2. The nut 35 temporarily held by the holding component 31 is held in the holding component 31 by the base plate portion 23A and suppressed from being separated from the holding component 31.

As shown in FIG. 5, the nut 35 is fit and accommodated between the pair of side plate portions 23B with the first terminal assembly 30 mounted in the housing body portion 21. Even if the nut 35 rotates in fastening the mating terminal 4 and the terminal 32, the rotation and position shift of the nut 35 are suppressed by the engagement of the pair of side plate portions 23B with the outer peripheral surface of the nut 35.

### (Configurations of Receptacle 24 and Terminal Accommodation Walls 25)

The receptacle 24 is formed to project from the mounting plate 22 toward a side opposite to the fitting portion 21B. As shown in FIG. 1, the receptacle 24 has a substantially rectangular tube shape when viewed from the first direction D1. As shown in FIG. 4, a pair of the terminal accommodation walls 25 are accommodated inside the receptacle 24. The terminal accommodation wall 25 has a substantially rectangular tube shape when viewed from the first direction D1. The respective terminal accommodation walls 25 are disposed at positions corresponding to the pair of upper and lower through holes 21A. The inside of the terminal accommodation wall 25 and the corresponding through hole 21A communicate.

An end opening of the through hole 21A on the side of the terminal accommodation wall 25 is formed in such a size that only the terminal 32 can be passed. Thus, a third sealing member 33 to be described later is held inside the housing body portion 21 and does not protrude toward the terminal accommodation wall 25 through the through hole 21A in the case of inserting the third sealing member 33 into the through hole 21A together with the terminal 32. Therefore, only the terminal 32 is disposed to project into the terminal accommodation wall 25 from the housing body portion 21.

### (Configuration of First Terminal Assembly 30)

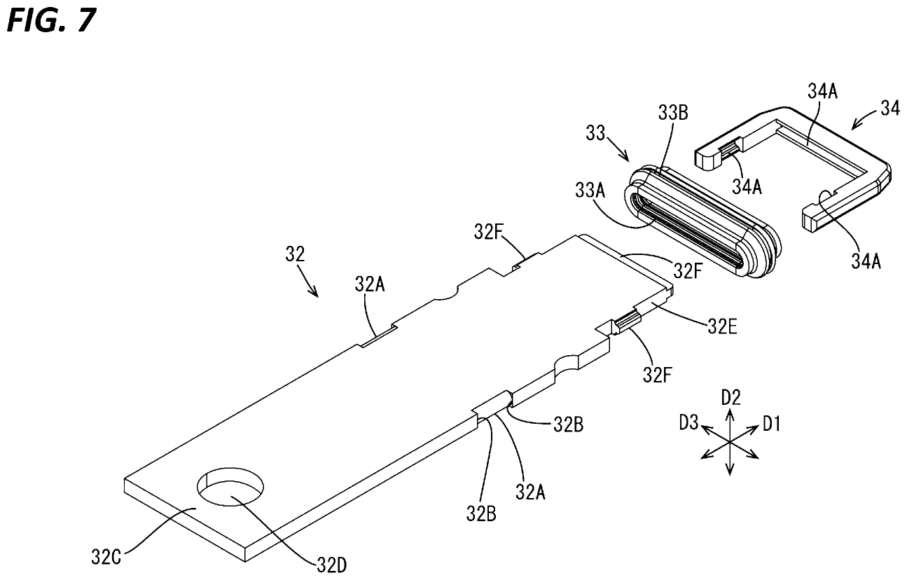

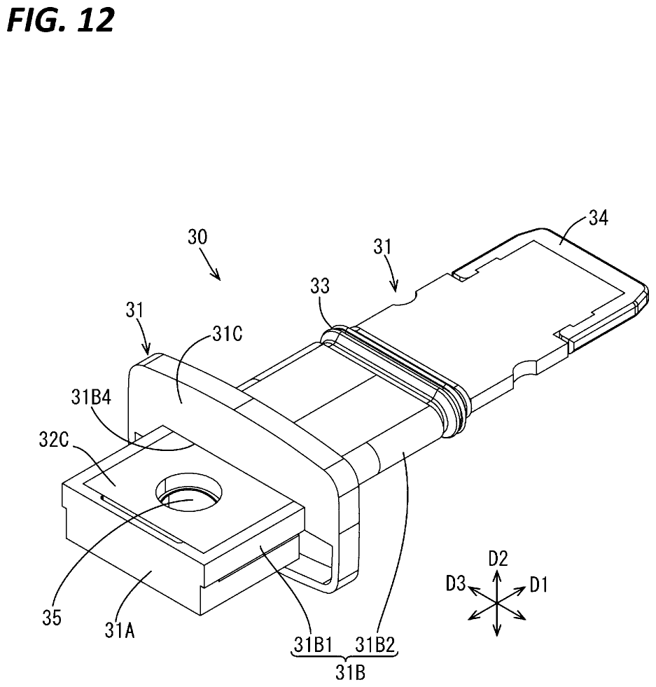

As shown in FIG. 12, the first terminal assembly 30 is provided with the holding component 31, the terminal 32, the third sealing member 33, an insulating member 34 and the nut 35. The third sealing member 33 is annular and directly mounted on the outer peripheral surface of the terminal 32. As shown in FIG. 4, the terminal 32 and the mating terminal 4 are connected by tightening a bolt B into the nut 35. As shown in FIG. 7, the third sealing member 33 has a laterally long oval ring shape when viewed from the first direction D1 and includes a plurality of inner peripheral lips 33A and a plurality of outer peripheral lips 33B. The third sealing member 33 corresponds to a “sealing member.”

### (Configuration of Terminal 32)

The terminal 32 is in the form of a substantially rectangular plate long in the first direction D1. Metal materials such as iron-based, copper-based and aluminum-based ones can be, for example, cited as a material of the terminal 32. A pair of sealing member mounting portions 32A are formed on both side edge parts in a central part of the terminal 32. The sealing member mounting portion 32A has a semicircular outer peripheral surface when viewed from the first direction D1. If the third sealing member 33 is mounted on the terminal 32 in the first direction D1, the inner peripheral lips 33A are held in close contact with the outer peripheral surfaces of the sealing member mounting portions 32A and the upper and lower surfaces of the terminal 32.

A pair of steps 32B are formed in both end parts in the first direction D1 of the sealing member mounting portion 32A. A movement of the third sealing member 33 in the first direction D1 is suppressed by the steps 32B. The third sealing member 33 is positioned and held in the pair of sealing member mounting portions 32A.

The terminal connecting portion 32C is formed on one end part in the first direction D1 of the terminal 32. A bolt insertion hole 32D is formed to penetrate through the terminal connecting portion 32C in a plate thickness direction. On the other hand, an insulating member mounting portion 32E is formed on the other end part in the first direction D1 of the terminal 32. The substantially gate-shaped insulating member 34 is mounted on the insulating member mounting portion 32E in the first direction D1. The insulating member 34 is made of an insulating resin material.

A plurality of protrusions 32F are formed on the outer peripheral edge of the insulating member mounting portion 32E. On the other hand, a plurality of recesses 34 are formed on the inner peripheral edge of the insulating member 34. The insulating member 34 is held on the insulating member mounting portion 32E by convex-concavely fitting the respective protrusions 32F into the respective recesses 34A in three different directions.

### (Configuration of Nut 35)

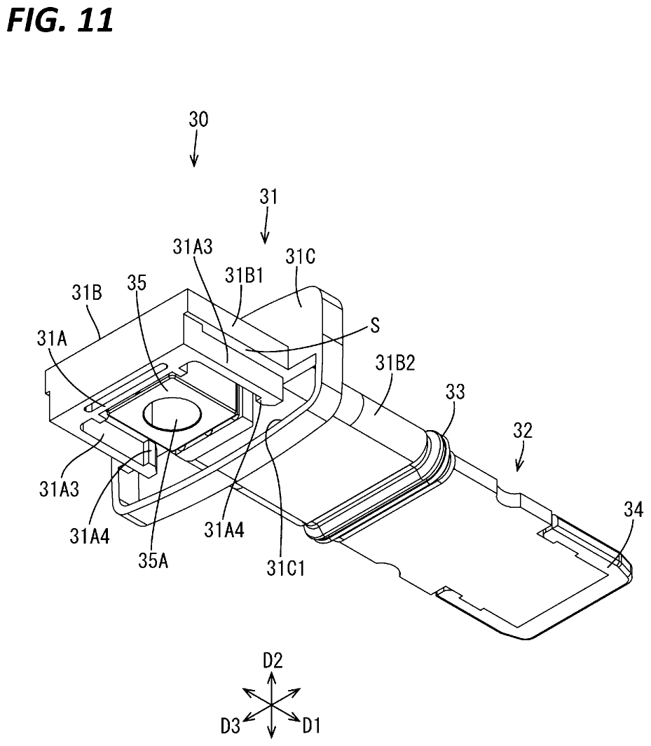

As shown in FIG. 11, the nut 35 is, for example, in the form of a quadrangular prism. The nut 35 includes a through hole 35A penetrating through the nut 35 in a thickness direction. The through hole 35A is formed to penetrate from the upper surface to the lower surface of the nut 35. The through hole 35A is, for example, formed to have a circular shape when viewed from a penetration direction (here, the second direction D2) of the through hole 35A. The through hole 35A is, for example, formed in centers of the upper and lower surfaces. The through hole 35A is, for example, disposed coaxially with the bolt insertion hole 32D of the terminal connecting portion 32C with the terminal 32 and the nut 35 mounted in the holding component 31. The nut 35 is, for example, formed to have a rectangular shape in a plan view from the penetration direction of the through hole 35A. The outer peripheral surface of the nut 35 is constituted by four flat outer peripheral side surfaces.

### (Configuration of Holding Component 31)

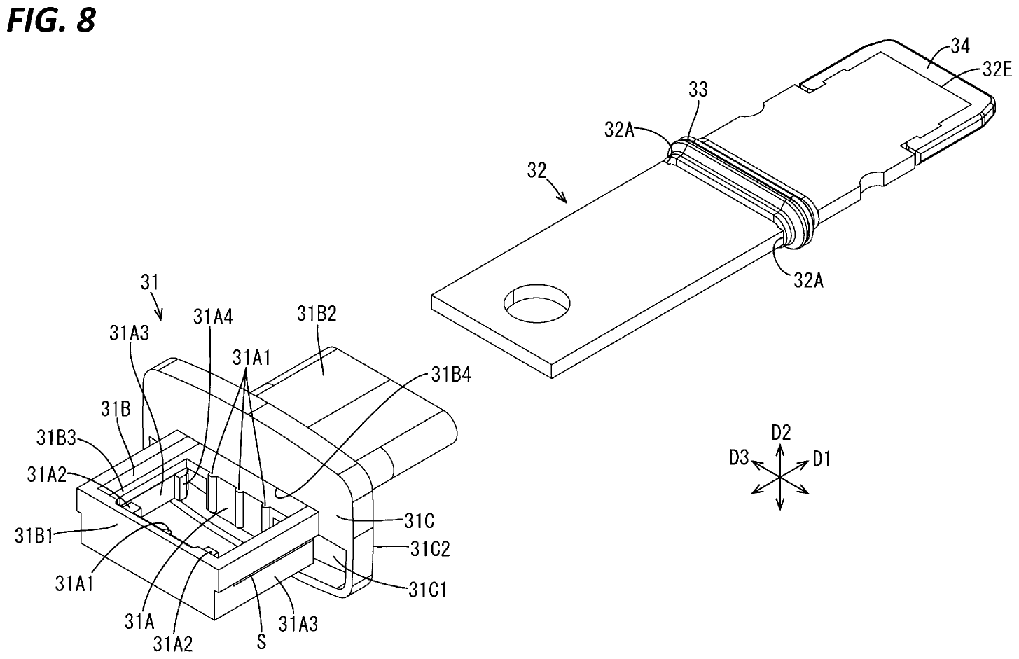

As shown in FIGS. 8 and 12, the holding component 31 includes a nut accommodating portion 31A for accommodating the nut 35 inside, a terminal accommodating portion 31B for accommodating the terminal 32 inside and a plate-like flange portion 31C arranged to be orthogonal to the terminal 32. The nut accommodating portion 31A is provided to be continuous with the terminal accommodating portion 31B.

The holding component 31 is made of a resin material softer than the housing 20. The nut accommodating portion 31A corresponds to a “nut positioning portion” and the terminal accommodating portion 31B corresponds to a “terminal positioning portion.”

### (Configuration of Nut Accommodating Portion 31A)

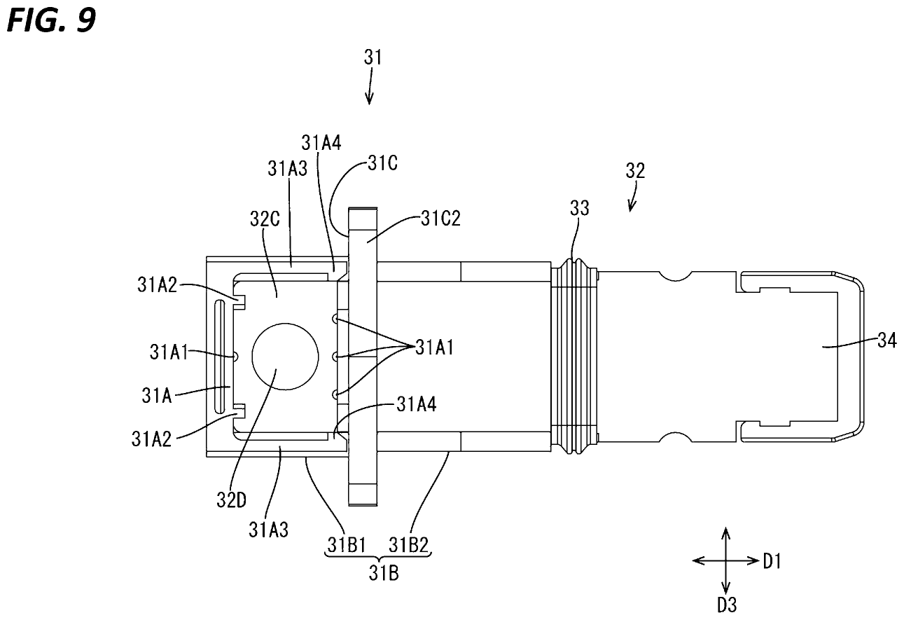

The nut accommodating portion 31A is in the form of a substantially rectangular frame open in the second direction D2. As shown in FIG. 9, a plurality of temporary holding ribs 31A1 in the form of ribs extending in the second direction D2 are formed on wall portions facing each other in the first direction D1, out of the peripheral wall of the nut accommodating portion 31A. In this embodiment, one temporary holding rib 31A1 is disposed on the front wall portion (wall portion on a side opposite to the flange portion 31C) of the nut accommodating portion 31A, and three temporary holding ribs 31A1 are disposed on the rear wall portion (wall portion on the side of the flange portion 31C).

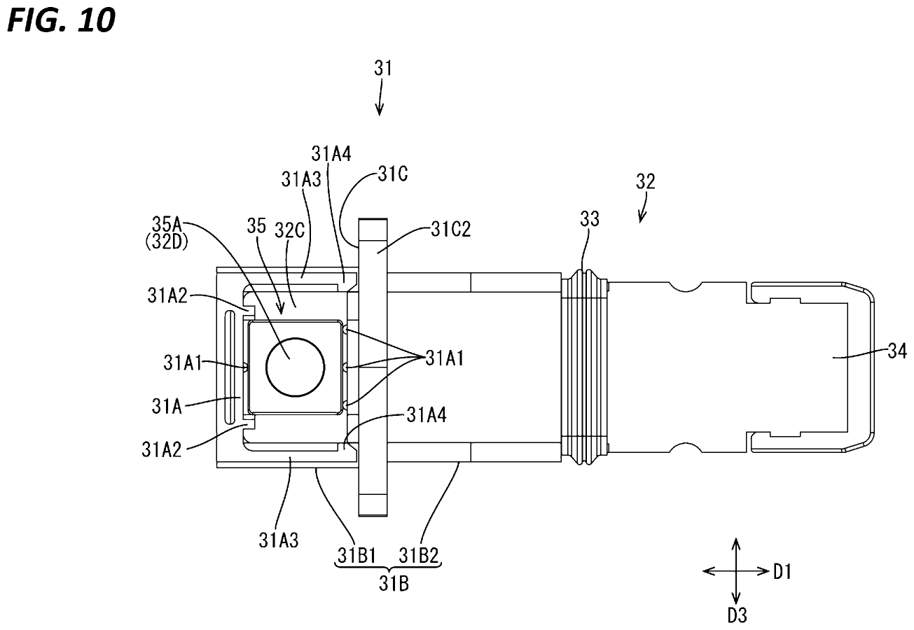

A pair of positioning ribs 31A2 are formed on the front wall portion of the nut accommodating portion 31A. The pair of positioning ribs 31A2 are in the form of ribs extending in the second direction D2 and symmetrically disposed with respect to the temporary holding rib 31A1 on the front wall portion as a center. As shown in FIG. 10, the pair of positioning ribs 31A2 can position the nut 35 in the third direction D3 by contacting the nut 35. The nut 35 is positioned and temporarily held in the third direction D3 by the pair of positioning ribs 31A2 and positioned and temporarily held in the first direction D1 by the plurality of temporary holding ribs 31A1.

In temporarily holding the nut 35 by the holding component 31, the nut 35 is mounted into the nut accommodating portion 31A of the holding component 31 in the second direction D2. Since the holding component 31 is made of the resin material softer than the housing 20, a press-fitting machine is not necessary and the nut 35 can be mounted by hand. Further, since the nut 35 is positioned in the first and third directions D1, D3 by the temporary holding ribs 31A1 and the positioning ribs 31A2, problems such as a position shift during press-fitting can be prevented.

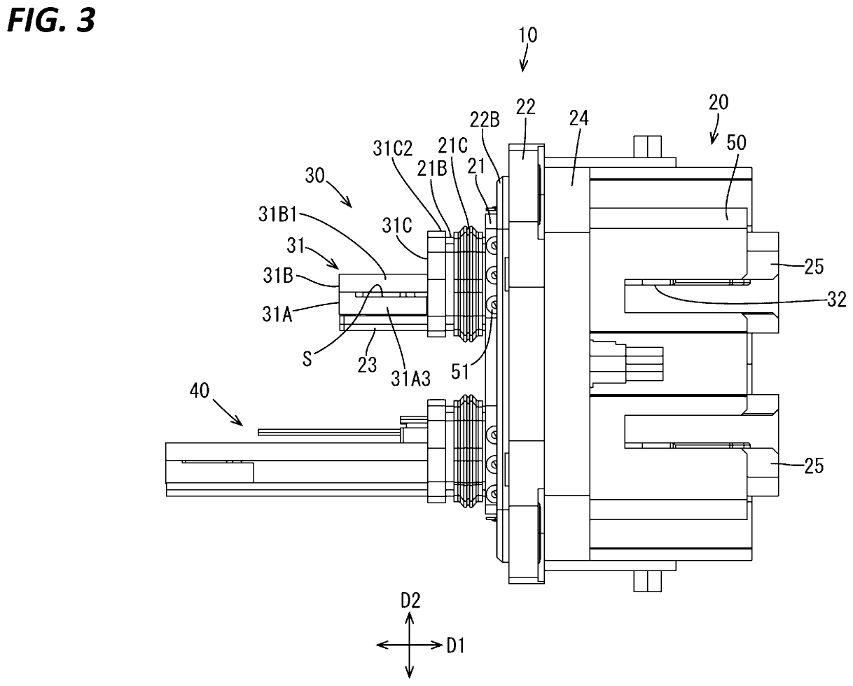

As shown in FIGS. 3 and 11, slits S are formed in wall portions facing each other in the third direction D3, out of the peripheral wall of the nut accommodating portion 31A, and deflection pieces 31A3 separated from the front accommodating portion 31B 1 are provided by these slits S. The deflection piece 31A3 is in the form of a cantilever projecting toward the flange portion 31C with the side of the positioning ribs 31A2 of the nut accommodating portion 31A as a base end part. A pair of the deflection pieces 31A3 are provided to face each other in the third direction D3. A pair of locking portions 31A4 are formed on facing parts of free end parts of the pair of deflection pieces 31A3.

As shown in FIG. 5, with the first terminal assembly 30 mounted in the housing 20, the pair of locking portions 31A4 are locked to the pair of locked portions 23C, whereby the first terminal assembly 30 is held in the housing 20. While the first terminal assembly 30 is being mounted into the housing 20, the deflection pieces 31A3 are so deflected and deformed that the locking portions 31A4 ride on the locked portions 23C. At the same time as the locking portions 31A4 ride over the locked portions 23C, the deflection pieces 31A3 are restored. Therefore, the first terminal assembly 30 can be mounted into the housing 20 by hand.

### (Configuration of Terminal Accommodating Portion 31B)

As shown in FIG. 8, the terminal accommodating portion 31B is provided to penetrate through the flange portion 31C in the first direction D1. The terminal accommodating portion 31B includes the front accommodating portion 31B1 integrally formed to the nut accommodating portion 31A and a rear accommodating portion 31B2 formed on a side opposite to the front accommodating portion 31B1 across the flange portion 31C.

The front accommodating portion 31B1 is in the form of a substantially rectangular frame open in the vertical direction. The terminal connecting portion 32C of the terminal 32 is accommodated into the front accommodating portion 31B1. The terminal connecting portion 32C comes into contact with a front wall portion facing the flange portion 31C, out of the peripheral wall of the front accommodating portion 31B1, in the first direction D1 to stop in front, whereby the terminal connecting portion 32C is positioned in the first direction D1. Further, the terminal connecting portion 32C comes into contact with a facing wall portion facing in the third direction D3, out of the peripheral wall of the front accommodating portion 31B1, in the third direction D3, whereby the terminal connecting portion 32C is positioned in the third direction D3.

A supporting surface 31B3 for supporting both side edge parts of the terminal connecting portion 32C is formed to be continuous with a lower end part of the facing wall portion of the front accommodating portion 31B1. The terminal connecting portion 32C comes into contact with the supporting surface 31B3 in the second direction D2, whereby the terminal connecting portion 32C is positioned in the second direction D2.

The rear accommodating portion 31B2 has a laterally long tubular shape and includes a terminal insertion hole 31B4 penetrating in the first direction D1. A part of the terminal 32 between the terminal connecting portion 32C and the sealing member mounting portions 32A (part surrounded by the third sealing member 33) is accommodated into the terminal insertion hole 31B4. The terminal 32 comes into contact with the peripheral wall of the terminal insertion hole 31B4 over an entire periphery, thereby being positioned in the second and third directions D2, D3.

With the terminal 32 mounted inside the terminal accommodating portion 31B, the terminal 32 is positioned in the first, second and third directions D1, D2 and D3. If the nut 35 is mounted into the nut accommodating portion 31A in the second direction D2 in this state, the nut 35 is positioned in the second direction D2 by the contact of the upper surface of the nut 35 with the lower surface of the terminal connecting portion 32C. Therefore, the nut 35, the terminal 32 and the third sealing member 33 are relatively positioned by one component, i.e. the holding component 31.

### (Configuration of Flange Portion 31C)

The flange portion 31C is in the form of a substantially rectangular plate when viewed from the first direction D1 and formed to protrude toward an outer peripheral side from the outer peripheral surface of the terminal accommodating portion 31B. An assembly opening 31C1 is provided to penetrate in the first direction D1 below the nut accommodating portion 31A in the flange portion 31C. The nut holding wall 23 is inserted through the assembly opening 31C1 when the first terminal assembly 30 is mounted into the housing body portion 21.

As shown in FIG. 4, the flange portion 31C includes a peripheral wall 31C2, and this peripheral wall 31C2 is fit to the outer peripheral surface of the fitting portion 21B and the outer peripheral surface of the nut holding wall 23. By externally fitting the peripheral wall 31C2 to the fitting portion 21B and the nut holding wall 23 in this way, the holding component 31 is positioned in the second and third directions D2, D3 with respect to the housing 20. Further, the first terminal assembly 30 is positioned in the first direction D1 with respect to the housing body portion 21 by the contact of the tip of the fitting portion 21B with the flange portion 31C.

As shown in FIG. 5, the peripheral wall 31C2 has a function of positioning the first sealing member 21C fit on the outer peripheral surface of the fitting portion 21B. If the first sealing member 21C is mounted on the outer peripheral surface of the fitting portion 21B and the first terminal assembly 30 is mounted in the housing body portion 21, the peripheral wall 31C2 is externally fit to the outer peripheral surface of the fitting portion 21B, whereby the first sealing member 21C is prevented from being separated from the outer peripheral surface of the fitting portion 21B and positioned and held on the outer peripheral surface of the fitting portion 21B.

### (Assembly Method of First Terminal Assembly 30)

Next, an assembly method of the first terminal assembly 30 is described. First, as shown in FIG. 7, the third sealing member 33 and the insulating member 34 are mounted on the terminal 32. Then, as shown in FIG. 8, the third sealing member 33 is positioned and mounted in the pair of sealing member mounting portions 32A and the insulating member 34 is fixed to the insulating member mounting portion 32E.

Subsequently, the terminal 32 is mounted into the holding component 31 in the first direction D1. The terminal 32 is mounted while being positioned inside the terminal accommodating portion 31B. In this state, since the third sealing member 33 is in contact with an end part of the terminal accommodating portion 31B as shown in FIG. 9, a movement of the third sealing member 33 toward the flange portion 31C is prevented. Further, since the nut accommodating portion 31A is covered from above by the terminal connecting portion 32C, the nut 35 is mounted into the nut accommodating portion 31A in the second direction D2 (from the side opposite to the terminal connecting portion 32C).

As shown in FIG. 10, if the nut 35 is mounted into the nut accommodating portion 31A, the nut 35 is temporarily held while being sandwiched and positioned in the first direction D1 by the plurality of temporary holding ribs 31A1 and is positioned in the third direction D3 by contacting the pair of positioning ribs 31A2. Further, the nut 35 is positioned in the second direction D2 by the contact of the upper surface of the nut 35 with the lower surface of the terminal connecting portion 32C. In the above way, the assembly of the first terminal assembly 30 is completed.

As shown in FIG. 11, in an assembled state of the first terminal assembly 30, a relative positional relationship of the terminal 32, the third sealing member 33 and the nut 35 is determined by one component, i.e. the holding component 31. From this state, the first terminal assembly 30 is inserted into the fitting portion 21B of the housing 20 in the first direction D1 as shown in FIG. 6. During insertion, the tip of the terminal 32 enters the through hole 21A and the nut holding wall 23 enters the assembly opening 31C1 of the flange portion 31C. Further, the locking portions 31A4 of the holding component 31 ride on the locked portions 23C of the housing 20 and the deflection pieces 31A3 are deflected and deformed.

If the first terminal assembly 30 is properly mounted into the housing body portion 21, the peripheral wall 31C2 of the holding component 31 is externally fit to the fitting portion 21B and the tip of the fitting portion 21B comes into contact with the flange portion 31C as shown in FIG. 4, whereby the first terminal assembly 30 is positioned in the first direction D1 with respect to the housing body portion 21. Here, since the terminal 32 is positioned by the holding component 31, the third sealing member 33 is evenly squeezed between the terminal 32 and the inner wall of the through hole 21A and original waterproof performance is exhibited. As a result, the through hole 21A is sealed to stop water between the inside of the terminal accommodation wall 25 and the inside of the fitting portion 21B.

Further, as shown in FIG. 5, the nut 35 is tightly fit between the pair of side plate portions 23B and the outer peripheral surface of the nut 35 is engaged with the pair of side plate portions 23B. Here, since the housing 20 constituting the side plate portions 23B is made of the resin material harder and more durable than the holding component 31, the nut 35 positioned by the holding component 31 can be suppressed from rotating when the bolt is tightened.

### Functions and Effects of Embodiment

(1) The connector 10 is to be connected to the mating device 1 and provided with the housing 20 to be fixed to the enclosure 2 of the mating device 1 and the first terminal assembly 30 fittable to the mating housing 3 provided in the enclosure 2. The housing 20 includes the housing body portion 21 having the through hole 21A penetrating in the first direction D1. The first terminal assembly 30 is mounted into the housing body portion 21 by being inserted into the through hole 21A in the first direction D1. The first terminal assembly 30 includes the terminal 32 arranged to penetrate through the housing body portion 21 in the first direction D1, the holding component 31 including the terminal insertion hole 31B4, into which the terminal 32 is inserted, and to be inserted into the through hole 21A together with the terminal 32, the third sealing member 33 for sealing between the inner wall of the through hole 21A and the terminal 32 by being directly mounted on the terminal 32 projecting from the terminal insertion hole 31B4, and the nut 35 to be mounted and temporarily held in the holding component 31 in the second direction D2 orthogonal to the first direction D1. The holding component 31 includes the terminal accommodating portion 31B for positioning the terminal 32 inserted into the terminal insertion hole 31B4, and the nut accommodating portion 31A provided to be continuous with the terminal accommodating portion 31B for positioning the nut 35. The housing 20 includes the nut holding wall 23 for holding the nut 35 in the state positioned by the nut accommodating portion 31A.

Since the nut 35 is mounted into and temporarily held in the holding component 31 in the second direction D2, the nut 35 needs not be press-fit and problems such as the forgetting to press-fit the nut 35 and a position shift of the nut 35 during press-fitting can be prevented. Further, since the third sealing member 33 is directly mounted on the terminal 32, the terminal 32 and the third sealing member 33 are positioned by the terminal accommodating portion 31B and the nut 35 is positioned by the nut accommodating portion 31A by respectively mounting the terminal 32 and the nut 35 into the holding component 31. As a result, the first terminal assembly 30 including the terminal 32, the nut 35 and the third sealing member 33 relatively positioned by one component, i.e. the holding component 31, can be configured, and a component for positioning the third sealing member 33 is not necessary in addition to the holding component 31. Thus, component cost can be reduced.

Since the nut can be held positioned by the nut holding wall 23, the positioning accuracy of the nut 35 can be improved. Here, in fastening the mating terminal 4 and the terminal 32 by the bolt B and the nut 35, the mating terminal 4 and the terminal 32 are fastened on the basis of the position of the nut 35 held positioned. That is, since the terminal 32 is not shifted in position by fastening and the terminal 32 is held positioned, a waterproof function can be ensured by evenly squeezing the third sealing member 33.
(2) The nut holding wall 23 includes the base plate portion 23A for suppressing the separation of the nut 35 by arranging the nut 35 between the terminal 32 and the base plate portion 23A.

Since the nut 35 is arranged between the base plate portion 23A and the terminal 32, the separation of the temporarily held nut 35 from the holding component 31 can be suppressed.
(3) The nut holding wall 23 includes the side plate portions 23B for stopping the rotation of the nut 35 by engaging the outer peripheral surface of the nut 35.

Since the side plate portions 23B engage the outer peripheral surface of the nut 35, the nut 35 can be suppressed from rotating and being shifted in position when the mating terminal 4 and the terminal 32 are fastened.
(4) The side plate portions 23B include the locked portions 23C and the holding component 31 includes the locking portions 31A4 for holding the first terminal assembly 30 in the state mounted in the housing body portion 21 by locking the locked portions 23C.

If the first terminal assembly 30 is mounted into the housing body portion 21, the locking portions 31A4 of the holding component 31 lock the locked portions 23C of the side plate portions 23B, whereby the first terminal assembly 30 can be held in the housing body portion 21.
(5) The holding component 31 includes the deflectable deflection pieces 31A3, and the locking portions 31A4 are provided on the deflection piece 31A3.

If the deflection pieces 31A3 are deflected and deformed while the first terminal assembly 30 is being mounted into the housing 20, the locking portions 31A4 ride over the locked portions 23C, and the deflection pieces 31A3 are restored at the same time as the locking portions 31A4 ride over the locked portions 23C. In this way, the locking portions 31A4 lock the locked portions 23C, wherefore the first terminal assembly 30 can be easily mounted into the housing body portion 21 by hand.
(6) The nut accommodating portion 31A includes the temporary holding ribs 31A1 extending in the second direction D2 and configured to sandwich and temporarily hold the nut 35 in the first direction D1.

The nut 35 can be temporarily held in the holding component 31 by being sandwiched in the first direction D1 by the temporary holding ribs 31A1.

### OTHER EMBODIMENTS

The above embodiment can be modified and carried out as follows. The above embodiment and the following modifications can be carried out in combination without technically contradicting each other.
Although the connector 10 provided with the first and second terminal assemblies 30, 40 is illustrated in the above embodiment, a connector may include only the first terminal assembly 30.
Although the base plate portion 23A of the nut holding wall 23 directly holds the nut 35 in the above embodiment, a nut holding wall may indirectly hold the nut 35 via a holding component. For example, a nut accommodating portion of the holding component may be formed with a bottom wall and a base plate portion of a nut holding wall may be disposed along the lower surface of the bottom wall of the nut accommodating portion after a nut is mounted into the nut accommodating portion from above and supported by the bottom wall.
Although the rotation of the nut 35 is stopped by engaging the pair of side plate portions 23B with the outer peripheral surface of the nut 35 in the above embodiment, the rotation of a nut may be stopped by forming a projection on the outer peripheral surface of the nut and forming a hole, into which this projection is fit, in the housing.
Although the holding component 31 is formed with the deflection pieces 31A3 in the above embodiment, side plate portions of a housing may be formed with deflection pieces.
The embodiment disclosed this time should be considered illustrative in all aspects, rather than restrictive. The scope of the present invention is represented not by the above meaning, but by claims and is intended to include all changes in the scope of claims and in the meaning and scope of equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a housing; and
a terminal assembly,
the housing including a housing body portion having a through hole penetrating in a first direction,
the terminal assembly including a terminal, a holding component to be inserted into the through hole together with the terminal, a sealing member for sealing between an inner wall of the through hole and the terminal by being directly mounted on the terminal and a nut to be mounted and temporarily held in the holding component,
the holding component including a terminal insertion hole, the terminal being inserted into the terminal insertion hole, a terminal positioning portion for positioning the terminal inserted into the terminal insertion hole, and a nut positioning portion provided to be continuous with the terminal positioning portion for positioning the nut, and
the housing including a nut holding wall for holding the nut in a state positioned by the nut positioning portion.

2. The connector of claim 1, wherein the nut holding wall includes a base plate portion for suppressing separation of the nut by arranging the nut between the terminal and the base plate portion.

3. The connector of claim 1, wherein the nut holding wall includes a side plate portion for stopping rotation of the nut by engaging an outer peripheral surface of the nut.

4. The connector of claim 3, wherein:
the side plate portion includes a locked portion, and
the holding component includes a locking portion for holding the terminal assembly in a state mounted in the housing body portion by locking the locked portion.

5. The connector of claim 4, wherein the holding component includes a deflectable deflection piece and the locking portion is provided on the deflection piece.

6. The connector of claim 1, wherein the nut positioning portion includes a temporary holding rib for sandwiching and temporarily holding the nut in the first direction.
